(19) United States
(12) Patent Application Publication
(10) Pub. No.: US 2026/0255264 A1
(43) Pub. Date: Aug. 27, 2026

(54) ENHANCED NETWORK FUNCTION REGISTRATION AND DISCOVERY

(71) Applicant: Telefonaktiebolaget LM Ericsson (publ), Stockholm (SE)

(72) Inventors: Yingjiao HE, Shanghai (CN); Yunjie LU, Shanghai (CN); Wen ZHANG, Shanghai (CN); Zhansheng WEI, Shanghai (CN); Juan XU, Shanghai (CN)

(21) Appl. No.: 18/994,266

(22) PCT Filed: Jul. 3, 2023
(86) PCT No.: PCT/EP2023/068155

§ 371 Date: Jan. 14, 2025

(30) Foreign Application Priority Data
Jul. 15, 2022 (WO) PCT/CN2022/105981

(51) Int. Cl. H04W 48/20; H04W 12/06; H04W 48/16; H04W 60/00

(52) U.S. Cl. CPC H04W 48/20; H04W 12/06; H04W 48/16; H04W 60/00

(57) ABSTRACT

The present disclosure is related to methods and network nodes for enhanced NF registration and discovery. A method at a first network node for selecting a second network node to serve a UE includes determining the second network node based on at least first information indicating a pool and/or a source from which an IP address and/or an IP prefix are to be allocated to the UE.

### TECHNICAL FIELD

The present disclosure is related to the field of telecommunication, and in particular, to methods and network nodes for enhanced network function (NF) registration and discovery.

### BACKGROUND

With the development of the electronic and telecommunications technologies, mobile devices, such as a mobile phone, a smart phone, a laptop, a tablet, a vehicle mounted device, becomes an important part of our daily lives. To support a numerous number of mobile devices, a highly efficient telecommunication system, such as a fifth generation system (5GS), will be required.

Third Generation Partnership Project (3GPP) 5^{th} Generation (5G) supports a registration and discovery mechanism that enables Core Network (CN) entities to discover a set of Network Function (NF) instance(s) and NF service instance(s) for a specific NF service or an NF type. NFs that provide services which can be discovered and used by other entities, nodes or NFs are also called producer NFs. Unless the expected NF and NF service information is locally configured in the requester NF, the NF and NF service discovery is implemented via the Network Repository Function (NRF). NRF is the logical function that is used to support the functionality of NF and NF service discovery and status notification as specified in clause 6.2.6 of TS 23.501.

In order for the requested NF type or NF service to be discovered via the NRF, the NF instance need to be registered in the NRF. This is done by sending a Nnrf_NFManagement_NFRegister containing the NF profile. The NF profile contains information related to the NF instance, such as NF instance ID, supported NF service instances. The registration may take place e.g. when the producer NF instance and its NF service instance(s) become operative for the first time.

In order for the requester NF to obtain information about the NF and/or NF service(s) registered or configured in a PLMN or in a network slice, based on local configuration the requester NF may initiate a discovery procedure with the NRF by providing the type of the NF and optionally a list of the specific service(s) it is attempting to discover.

### SUMMARY

According to a first aspect of the present disclosure, a method at a first network node for selecting a second network node to serve a User Equipment (UE) is provided. The method comprises: determining the second network node based on at least first information indicating a pool and/or a source from which an Internet Protocol (IP) address and/or an IP prefix are to be allocated to the UE.

In some embodiments, the step of determining the second network node comprises: transmitting, to a third network node, a first message for discovering one or more second network nodes, the first message further comprising the first information; receiving, from the third network node, a second message indicating at least one second network node that is able to handle the pool and/or the source indicated by the information; and selecting one of the at least one second network node as the second network node that is to serve the UE. In some embodiments, the step of determining the second network node comprises: transmitting, to a third network node, a first message for discovering one or more second network nodes; receiving, from the third network node, a second message indicating at least one second network node; and selecting one of the at least one second network node that is able to handle the pool and/or the source indicated by the first information, as the second network node that is to serve the UE.

In some embodiments, the first information indicates at least one of: an IP Version 4 (IPv4) address pool used to allocate the IP address; an IP Version 6 (IPv6) prefix pool used to allocate the IP address and/or the IP prefix; and an external server used to allocate the IP address and/or the IP prefix. In some embodiments, before the step of determining the second network node, the method further comprises at least one of: transmitting, to a fourth network node, a third message for requesting session management subscriber data associated with the UE; and receiving, from the fourth network node, a fourth message indicating the first information. In some embodiments, the third message further indicates at least one of Single Network Slice Selection Assistance Information (S-NSSAI) and/or a Data Network Name (DNN) subscribed by the UE. In some embodiments, the first information is comprised in a DNN configuration associated with the S-NSSAI and/or the DNN.

In some embodiments, before the step of determining the second network node, the method further comprises at least one of: transmitting, to a fifth network node, a fifth message for authenticating and/or authorizing the UE with the fifth network node; and receiving, from the fifth network node, a sixth message indicating the first information. In some embodiments, the fifth message further indicates a DNN subscribed by the UE. In some embodiments, the method further comprises: communicating with the determined second network node to establish a session for the UE. In some embodiments, at least one of following is true: the first network node is a Session Management Function (SMF) or a Packet Data Network (PDN) Gateway-Control plane function (PGW-C); the second network node is a User Plane Function (UPF) or a PGW-User plane function (PGW-U); the third network node is a NRF; the fourth network node is a Unified Data Management (UDM); the fifth network node is a Data Network-Authentication, Authorization, and Accounting (DN-AAA) server; the first message is an Nnrf_NFDiscovery_Request request message; the second message is an Nnrf_NFDiscovery_Request response message; the third message is an Nudm_SDM_Get request message; the fourth message is an Nudm_SDM_Get response message; the fifth message is an Access Request message; and the sixth message is an Access Accept message.

According to a second aspect of the present disclosure, a first network node is provided. The first network node comprises: a processor; a memory storing instructions which, when executed by the processor, cause the processor to perform any of the methods of the first aspect.

According to a third aspect of the present disclosure, a first network node for selecting a second network node to serve a UE is provided. The first network node comprises: a determining module configured to determine the second network node based on at least first information indicating a pool and/or a source from which an IP address and/or an IP prefix are to be allocated to the UE. In some embodiments, the first network node comprise one or more further modules configured to configured to perform one or more steps of any of the methods of the first aspect.

According to a fourth aspect of the present disclosure, a method at a second network node for facilitating a first network node in selecting the second network node to serve a UE is provided. The method comprises: transmitting, to a third network node, a seventh message comprising second information indicating a pool and/or a source, from which an IP address and/or an IP prefix are able to be allocated, the pool and/or the source being able to be handled by the second network node.

In some embodiments, the second information indicates at least one of: an IPv4 address pool used to allocate the IP address; an IPv6 prefix pool used to allocate the IP address and/or the IP prefix; and an external server used to allocate the IP address and/or the IP prefix. In some embodiments, the method further comprises: communicating with the first network node to establish a session for the UE. In some embodiments, the seventh message is a message for registering an NF profile for the second network node at the third network node. In some embodiments, the method further comprises: receiving, from the third network node, an eighth message indicating whether the registration is successful or not. In some embodiments, at least one of following is true: the first network node is an SMF or a PGW-C; the second network node is a UPF or a PGW-U; the third network node is an NRF; the seventh message is an Nnrf_NFManagement_NFRegister request message; and the eighth message is an Nnrf_NFManagement_NFRegister response message.

According to a fifth aspect of the present disclosure, a second network node is provided. The second network node comprises: a processor; a memory storing instructions which, when executed by the processor, cause the processor to perform any of methods of the fourth aspect.

According to a sixth aspect of the present disclosure, a second network node for facilitating a first network node in selecting the second network node to serve a UE is provided. The second network node comprises: a transmitting module configured to transmit, to a third network node, a seventh message comprising second information indicating a pool and/or a source, from which an IP address and/or an IP prefix are able to be allocated, the pool and/or the source being able to be handled by the second network node. In some embodiments, the second network node comprise one or more further modules configured to configured to perform one or more steps of any of the methods of the fourth aspect.

According to a seventh aspect of the present disclosure, a method at a third network node for enabling a second network node to be discoverable is provided. The method comprises: receiving, from one or more second network nodes, one or more seventh messages, each comprising second information indicating a pool and/or a source, from which an IP address and/or an IP prefix are able to be allocated, the pool and/or the source being able to be handled by a corresponding second network node.

In some embodiments, each of the one or more seventh messages is a message for registering an NF profile for a corresponding second network node at the third network node. In some embodiments, the method further comprises: transmitting, to at least one of the one or more second network nodes, an eighth message indicating whether the corresponding registration is successful or not. In some embodiments, the method further comprises: receiving, from a first network node, a first message for discovering one or more second network nodes, the first message further comprising first information indicating a pool and/or a source from which an IP address and/or an IP prefix are to be allocated to a UE; determining at least one second network node in response to determining that the second information corresponding to the at least one second network node matches with the first information; transmitting, to the first network node, a second message indicating the determined at least one second network node.

In some embodiments, the method further comprises: receiving, from a first network node, a first message for discovering one or more second network nodes without the first information indicated; transmitting, to the first network node, a second message indicating at least one second network node registered at the third network node. In some embodiments, at least one of the first information and the second information indicates at least one of: an IPv4 address pool used to allocate the IP address; an IPv6 prefix pool used to allocate the IP address and/or the IP prefix; and an external server used to allocate the IP address and/or the IP prefix.

In some embodiments, at least one of following is true: the first network node is an SMF or a PGW-C; the second network node is a UPF or a PGW-U; the third network node is an NRF; the first message is an Nnrf_NFDiscovery_Request request message; the second message is an Nnrf_NFDiscovery_Request response message; the seventh message is an Nnrf_NFManagement_NFRegister request message; and the eighth message is an Nnrf_NFManagement_NFRegister response message.

According to an eighth aspect of the present disclosure, a third network node is provided. The third network node comprises: a processor; a memory storing instructions which, when executed by the processor, cause the processor to perform the method of the seventh aspect.

According to a ninth aspect of the present disclosure, a third network node for enabling a second network node to be discoverable is provided. The third network node comprises: a receiving module configured to receive, from one or more second network nodes, one or more seventh messages, each comprising second information indicating a pool and/or a source, from which an IP address and/or an IP prefix are able to be allocated, the pool and/or the source being able to be handled by a corresponding second network node. In some embodiments, the third network node comprise one or more further modules configured to configured to perform one or more steps of any of the methods of the seventh aspect.

According to a tenth aspect of the present disclosure, a computer program comprising instructions is provided. The instructions, when executed by at least one processor, cause the at least one processor to carry out any of the methods of any of the first, fourth, and seventh tenth aspects.

According to an eleventh aspect of the present disclosure, a carrier containing the computer program of the tenth aspect is provided. In some embodiments, the carrier is one of an electronic signal, optical signal, radio signal, or computer readable storage medium.

According to a twelfth aspect of the present disclosure, a telecommunication system for network node selection for a UE is provided. The telecommunication system comprises: a first network node of the second or third aspect; a second network node of the fifth or sixth aspect; and a third network node of the eighth and ninth aspect.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a block diagram illustrating an exemplary telecommunication network in which enhanced NF registration and discovery according to an embodiment of the present disclosure may be applicable.

FIG. 2 is a block diagram illustrating another exemplary telecommunication network in which enhanced NF registration and discovery according to another embodiment of the present disclosure may be applicable.

FIG. 3 is a diagram illustrating an exemplary procedure for enhanced NF registration and discovery according to an embodiment of the present disclosure.

FIG. 4 is a diagram illustrating another exemplary procedure for enhanced NF registration and discovery according to another embodiment of the present disclosure.

FIG. 5 is a flow chart illustrating an exemplary method at a first network node for selecting a second network node to serve a UE according to an embodiment of the present disclosure.

FIG. 6 is a flow chart illustrating an exemplary method at a second network node for facilitating a first network node in selecting the second network node to serve a UE according to an embodiment of the present disclosure.

FIG. 7 is a flow chart illustrating an exemplary method at a third network node for enabling a second network node to be discoverable according to an embodiment of the present disclosure.

FIG. 8 schematically shows an embodiment of an arrangement which may be used in one or more network nodes according to an embodiment of the present disclosure.

FIG. 9 is a block diagram of an exemplary first network node according to an embodiment of the present disclosure.

FIG. 10 is a block diagram of an exemplary second network node according to an embodiment of the present disclosure.

FIG. 11 is a block diagram of an exemplary third network node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also be understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, although the following description of some embodiments of the present disclosure is given in the context of 5G system (5GS), the present disclosure is not limited thereto. In fact, as long as NF registration and discovery is involved, the concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), Evolved Packet System (EPS), 5G New Radio (NR), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an Internet of Things (IoT) device, a vehicle, or any other equivalents. For another example, the term “network node” used herein may refer to a base station, a base transceiver station, an access point, a hot spot, a NodeB (NB), an evolved NodeB (eNB), a gNB, a network element, a network function, or any other equivalents.

Further, following 3GPP documents are incorporated herein by reference in their entireties:
3GPP TS 29.061 V17.6.0 (2022-03), Technical Specification, 3rd Generation Partnership Project; Technical Specification Group Core Network and Terminals; Interworking between the Public Land Mobile Network (PLMN) supporting packet based services and Packet Data Networks (PDN) (Release 17);
3GPP TS 29.503 V17.6.0 (2022-03), Technical Specification, 3rd Generation Partnership Project; Technical Specification Group Core Network and Terminals; 5G System; Unified Data Management Services; Stage 3 (Release 17);
3GPP TS 29.510 V17.5.0 (2022-03), Technical Specification, 3rd Generation Partnership Project; Technical Specification Group Core Network and Terminals; 5G System; Network Function Repository Services; Stage 3 (Release 17); and
3GPP TS 29.561 V17.6.0 (2022-06), Technical Specification, 3rd Generation Partnership Project; Technical Specification Group Core Network and Terminals; 5G System; Interworking between 5G Network and external Data Networks; Stage 3 (Release 17).

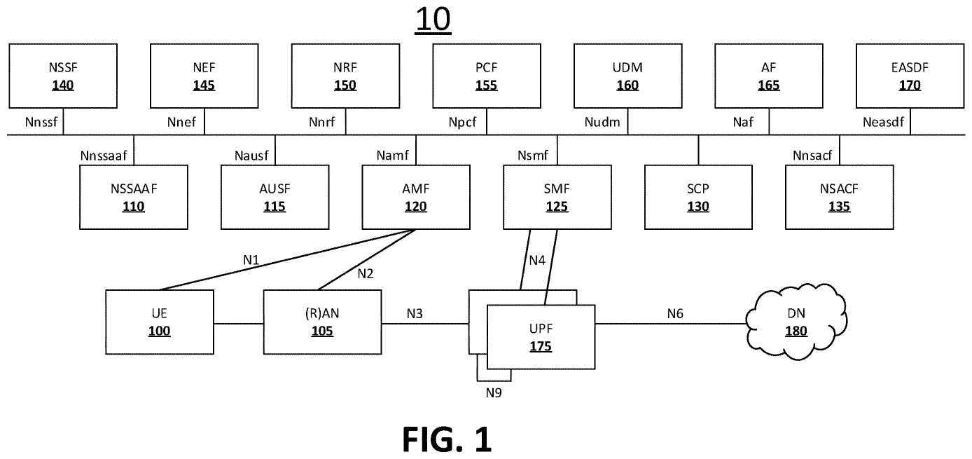

FIG. 1 is a block diagram illustrating an exemplary telecommunication network 10 in which enhanced NF registration and discovery according to an embodiment of the present disclosure may be applicable. Although the telecommunication network 10 is a network defined in the context of 5GS, the present disclosure is not limited thereto.

As shown in FIG. 1, the network 10 may comprise one or more UEs 100 and a (radio) access network ((R)AN) 105, which could be a base station, a Node B, an evolved NodeB (eNB), a gNB, or an Access Network (AN) node which provides the UEs 100 with access to other parts of the network 10. Further, the network 10 may comprise a core network portion comprising (but not limited to) a Network Slice-specific and SNPN (Stand-alone Non-Public Network) Authentication and Authorization Function (NSSAAF) 110, an Authentication Server Function (AUSF) 115, an Access and Mobility Management Function (AMF) 120, a Session Management Function (SMF) 125, a Service Communication Proxy (SCP) 130, a Network Slice Admission Control Function (NSACF) 135, a Network Slice Selection Function (NSSF) 140, a Network Exposure Function (NEF) 145, a Network Repository Function (NRF) 150, a Policy Control Function (PCF) 155, a Unified Data Management (UDM) 160, one or more Application Functions (AF) 165, an Edge Application Server Discovery Function (EASDF) 170, and one or more User Plane Functions (UPFs) 175. As shown in FIG. 1, these entities may communicate with each other via the service-based interfaces, such as, Nnrf, Nsmf, etc. and/or the reference points, such as, N1, N2, N3, N4, N6, N9, etc.

However, the present disclosure is not limited thereto. In some other embodiments, the network 10 may comprise additional network functions, less network functions, or some variants of the existing network functions shown in FIG. 1. For example, in a network with the 4G EPS architecture, the entities which perform these functions (e.g., PGW-C) may be different from those shown in FIG. 1 (e.g., the SMF 125). For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

As shown in FIG. 1, the UPFs 175 are communicatively connected to a Data Network (DN) 160 which may be, or in turn communicatively connected to, the Internet, such that the UE 100 may finally communicate its user plane data with other devices outside the network 10, for example, via the RAN 105 and the UPFs 175.

Some of the network functions shown in FIG. 1 that may be involved in some embodiments of the present disclosure will be described below.

In some embodiments, the SMF 125 may support (but not limited thereto) at least one of:
Session Management, e.g., Session Establishment, modify and release, including tunnel maintain between UPF 175 and AN node 105.
UE IP address allocation and/or management (including optional Authorization). The UE IP address may be received from a UPF 175 or from an external data network.
Selection and control of User Plane (UP) function, including controlling the UPF 175 to proxy Address Resolution Protocol (ARP) or IPv6 Neighbour Discovery, or to forward all ARP/IPv6 Neighbour Solicitation traffic to the SMF 125, for Ethernet Protocol Data Unit (PDU) Sessions.
Configures traffic steering at UPF 175 to route traffic to proper destination.

In some embodiments, the UPF 175 may support (but not limited thereto) at least one of:
Allocation of UE IP address/prefix (if supported) in response to SMF request.
External PDU Session point of interconnect to Data Network.
Packet routing & forwarding (e.g., support of Uplink classifier to route traffic flows to an instance of a data network, support of Branching point to support multi-homed PDU Session, support of traffic forwarding within a 5G VN group (UPF local switching, via N6, via N19)).

Some or all of the UPF functionalities may be supported in a single instance of a UPF.

In some embodiments, the NRF 150 may support (but not limited thereto) at least one of:
Supporting service discovery function. Receive NF Discovery Request from NF instance or the SCP 130, and provides the information of the discovered NF instances (be discovered) to the NF instance or the SCP 130.
Maintaining the NF profile of available NF instances and their supported services.
Notifying about newly registered/updated/deregistered NF and SCP instances along with its potential NF services to the subscribed NF service consumer or the SCP 130.
Maintaining the health status of NFs and the SCP 130.

In some embodiments, the UDM 160 may support (but not limited thereto) at least one of:
User Identification Handling (e.g., storage and management of Subscription Permanent Identifier (SUPI) for each subscriber in the 5G system).
Support of de-concealment of privacy-protected subscription identifier (SUCI or Subscription Concealed Identifier).
Access authorization based on subscription data (e.g., roaming restrictions).
UE's Serving NF Registration Management (e.g., storing serving AMF for UE, storing serving SMF for UE's PDU Session).
Subscription management.
Support of external parameter provisioning (Expected UE Behaviour parameters or Network Configuration parameters).

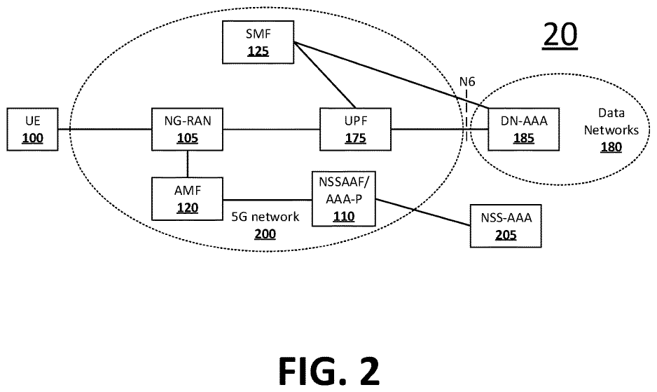

FIG. 2 is a block diagram illustrating another exemplary telecommunication network 20 in which enhanced NF registration and discovery according to another embodiment of the present disclosure may be applicable. Although the telecommunication network 20 is a network defined in the context of 5GS, the present disclosure is not limited thereto. Further, the network functions shown in FIG. 2 have similar or same reference numerals as corresponding network functions shown in FIG. 1, and repeated description thereof may be omitted for simplicity and clarity. Furthermore, some of network functions that are not explicitly shown in FIG. 2 but referenced below may be substantially similar or same as those shown and described with reference to FIG. 1, and therefore same reference numerals are used for such network functions.

As shown in FIG. 2, the network 20 may comprise at least two sub-networks: a 5G network 200 and one or more (external) data networks 180. However, the present disclosure is not limited thereto. In some other embodiments, the network 20 may comprise, for example, a 4G network, instead of the 5G network 200. Further, in some embodiments, the 5G network 200 may comprise additional network functions or different network functions. In some embodiments, the 5G network 200 may omit some network functions shown in FIG. 2.

As shown in FIG. 2, the 5G network 200 may comprise one or more UEs 100 and a Next Generation Radio Access Network (NG-RAN) 105, which could be a base station, a Node B, an eNB, a gNB, or an AN node which provides the UEs 100 with access to other parts of the network 10. Further, the network 200 may comprise its core network portion comprising (but not limited to) an optional NSSAAF/Authentication, Authorization, and Accounting Proxy (NSSAAF/AAA-P) 110, an AMF 120, an SMF 125, and a UPF 175.

As also shown in FIG. 2, at least one of the data networks 180 may comprise a DN-AAA server 185 for authentication, authorization, and/or accounting of the UE 100, for example, via the Remote Authentication Dial In User Service (RADIUS) protocol. However, the present disclosure is not limited thereto.

In some embodiments, a RADIUS client function may reside in the SMF 125. When the SMF 125 receives an initial access request (i.e. the SMF 125 receives the Nsmf_PDUSession_CreateSMContext request with type “Initial request” for non-roaming case or local breakout case, or the (H-)SMF 125 receives the Nsmf_PDUSession_Create Request with type “Initial request” for home routed case), the RADIUS client function may send the authentication information to the DN-AAA server 185, which is identified during the DNN provisioning.

The DN-AAA server 185 may perform authentication and authorization. The response (when positive) may contain network information, such as an IPv4 address and/or IPv6 prefix for the user when the SMF 125 is interworking with the DN-AAA server 185.

The information delivered during the RADIUS authentication can be used to automatically correlate the user identity (e.g., SUPI) to the IPv4 address and/or IPv6 prefix, if applicable, assigned/confirmed by the SMF 125 or the DN-AAA server 185 respectively.

For 5G, RADIUS Authentication is applicable to the initial access request. When the SMF 125 receives an Access-Accept message from the DN-AAA server 185, it may complete the initial access procedure. If Access-Reject or no response is received, the SMF 125 may reject the initial access procedure with a suitable cause code.

When the DN-AAA server 185 authorizes the PDU Session Establishment, it may send DN authorization data for the established PDU Session to the SMF 125.

The SMF 125 may also trigger request for DN authentication/authorization and/or IP address/prefix allocation based on UE subscription data retrieve from the UDM 160 as defined in clause 5.2.2.2.5 of 3GPP TS 29.503.

Further, in some embodiments where the DN-AAA server 185 located in 5GC or in the external PDN is reachable directly, the SMF 125 can communicate with the DN-AAA server 185 directly without involving the UPF 175, applicable to all the message flows on N6 interface described above.

Further, as also shown in FIG. 2, a Network Slice Specific AAA (NSS-AAA) server 205 may be provided. The NSS-AAA server 205 may belong to the H-PLMN in the 5G Network (without AAA-P interworking) or a 3rd party (with AAA-P interworking, as shown in FIG. 2). The Network Slice Specific Authentication and Authorization procedure may be triggered for a network slice requiring Network Slice Specific Authentication and Authorization with the NSS-AAA server 205 which may be hosted by the H-PLMN operator or by a third party which has a business relationship with the H-PLMN. The AAA Proxy (AAA-P) 110 in the HPLMN may be involved e.g., if the NSS-AAA Server belongs to a third party, as shown in FIG. 2.

As shown in FIG. 2, a RADIUS client function may reside in the NSSAAF 110. When the NSSAAF 110 receives Nnssaaf_NSSAA_Authenticate request from the AMF 120, the RADIUS client function may send the authentication information with network slice information to the NSS-AAA server 205 directly or via the AAA-P 110.

The NSS-AAA server 205 may perform authentication and authorization for the user and requested network slice information. When the NSSAAF 110 receives an Access-Accept message from the NSS-AAA server 205 or the AAA-P 110, it may complete the network slice specific authentication procedure. If Access-Reject or no response is received, the NSSAAF 110 may reject the network slice specific authentication procedure with a suitable cause code.

As described with reference to FIG. 1 and FIG. 2, there are multiple methods for IP address/prefix allocation to a UE 100. For example, at least following methods are provided:
a. During PDU Session Establishment procedure, the SMF 125 may send the IP address to the UE 100 via SM NAS signalling. The IPv4 address allocation and/or IPv4 parameter configuration via DHCPv4 can also be used once PDU Session is established.
b. /64 IPv6 prefix allocation may be supported via IPv6 Stateless Auto-configuration according to RFC 4862, if IPv6 is supported. IPv6 parameter configuration via Stateless DHCPv6 (according to RFC 3736) may also be supported.

To allocate the IP address via DHCPv4, the UE 100 may indicate to the network within the Protocol Configuration Options (PCO) that the UE 100 requests to obtain the IPv4 address with DHCPv4, or obtain the IP address during the PDU Session Establishment procedure. This implies the following behaviour both for static and dynamic address allocation:
The UE 100 may indicate that it requests to obtain an IPv4 address as part of the PDU Session Establishment procedure. In such a case, the UE 100 may rely on the 5GC network to provide IPv4 address to the UE 100 as part of the PDU Session Establishment procedure.
The UE 100 may indicate that it requests to obtain the IPv4 address after the PDU Session Establishment procedure by DHCPv4. That is, when the 5GC network supports DHCPv4 and allows that, it does not provide the IPv4 address for the UE 100 as part of the PDU Session Establishment procedure. The network may respond to the UE 100 by setting the allocated IPv4 Address to 0.0.0.0. After the PDU Session Establishment procedure is completed, the UE 100 may use the connectivity with the 5GC and initiate the IPv4 address allocation on its own using DHCPv4. However, if the 5GC network provides IPv4 address to the UE 100 as part of the PDU Session Establishment procedure, the UE 100 should accept the IPv4 address indicated in the PDU Session Establishment procedure.
If the UE 100 sends no IP Address Allocation request, the SMF 125 may determine whether DHCPv4 is used between the UE 100 and the SMF 125 or not, e.g. based on DNN configuration.

If dynamic policy provisioning is deployed, and the PCF 155 was not informed of the IPv4 address at PDU Session Establishment procedure, the SMF 125 may inform the PCF 155 about an allocated IPv4 address. If the IPv4 address is released, the SMF 125 may inform the PCF 155 about the de-allocation of an IPv4 address.

In some embodiments, in order to support DHCP based IP address configuration, the SMF 125 may act as the DHCP server towards the UE 100. The PDU Session Anchor UPF 175 does not have any related DHCP functionality. The SMF 125 may instruct the PDU Session Anchor UPF 175 serving the PDU Session to forward DHCP packets between the UE 100 and the SMF 125 over the user plane.

When DHCP is used for external data network (e.g. the data network 180 shown in FIG. 2) assigned addressing and parameter configuration, the SMF 125 may act as the DHCP client towards the external DHCP server. The UPF 175 does not have any related DHCP functionality. In the case of DHCP server on the external data network, the SMF 125 may instruct a UPF 175 with N6 connectivity to forward DHCP packets between the UE 100 and the SMF 125 and the external DHCP server over the user plane. For example, as shown in FIG. 2, the DN-AAA server 185 and/or the NSS-AAA server 205 may play the role of the external DHCP server.

The 5GC may also support the allocation of a static IPv4 address and/or a static IPv6 prefix based on subscription information in the UDM 160 or based on the configuration on a per-subscriber, per-DNN basis and per-S-NSSAI.

If the static IP address/prefix is stored in the UDM 160, during PDU Session Establishment procedure, the SMF 125 may retrieve this static IP address/prefix from the UDM 160. If the static IP address/prefix is not stored in the UDM subscription record, it may be configured on a per-subscriber, per-DNN and per-S-NSSAI basis in the DHCP/DN-AAA server 185 and the SMF 125 may retrieve the IP address/prefix for the UE 100 from the DHCP/DN-AAA server 185. This IP address/prefix may be delivered to the UE 100 in the same way as a dynamic IP address/prefix. It is transparent to the UE 100 whether the PLMN or the external data network allocates the IP address and whether the IP address is static or dynamic.

For IPv4 or IPv6 or IPv4v6 PDU Session Type, during PDU Session Establishment procedure, the SMF 125 may receive a Subscriber's IP Index from the UDM 160. If the UE IP address/prefix was not already allocated and provided to PCF 155 when SMF 125 initiates the SM policy association, the SMF 125 may receive a Subscribers IP Index from the PCF 155. If the SMF 125 received a Subscriber's IP index from both UDM 160 and PCF 155, the SMF 125 may apply the Subscriber's IP Index received from the PCF 155. The SMF 125 may use the Subscriber's IP Index to assist in selecting how the IP address is to be allocated when multiple allocation methods, or multiple instances of the same method are supported.

In some embodiments, the IP Index can e.g. be used to select between different IP pools, including between IP pools with overlapping private address range. To support deployments with overlapping private IPv4 address, the IP domain corresponding to IP index can also be provided from UDM 160 to SMF 125 as part of the subscription data and then provided to PCF 155.

When Static IP addresses for a PDU session are not used, the actual allocation of the IP Address(es) for a PDU Session may use any of the following mechanisms:
The SMF 125 may allocate the IP address from a pool that corresponds to the PDU Session Anchor (UPF 175) that has been selected.
The UE IP address may be obtained from the UPF 175. In that case the SMF 125 may interact with the UPF 175 via N4 procedures to obtain a suitable IP address. The SMF 125 may provide the UPF 175 with the necessary information allowing the UPF 175 to derive the proper IP address (e.g., the network instance).
In the case that the UE IP address is obtained from the external data network (e.g., the DN 180), additionally, the SMF 125 may also send the allocation, renewal and release related request messages to the external data network, i.e., DHCP/DN-AAA server 185, and maintain the corresponding state information. The IP address allocation request sent to DHCP/DN-AAA server 185 may include the IP address pool ID to identify which range of IP address is to be allocated. In this case the SMF 125 may be provisioned with separate IP address pool ID(s), and the mapping between IP address pool ID and UPF Id, DNN, S-NSSAI, and/or IP version. The provision is done by OAM or during the N4 Association Setup procedure.

A given IP address pool may be controlled by a unique entity (either the SMF 125 or the UPF 175 or an external server (e.g., the DN-AAA 185 or the NS-AAA 205)). The IP address managed by the UPF 175 can be partitioned into multiple IP address pool partition(s), i.e., associated with multiple IP address pool ID(s).

When the SMF 125 is configured to obtain UE IP addresses from the UPF 175, the SMF 125 may select a UPF 175 based upon support of this feature. The SMF 125 may determine whether the UPF supports this feature via NRF 150 or via N4 capability negotiation during N4 Association Setup. If no appropriate UPF 175 supports the feature, the SMF 125 may allocate UE IP addresses, if configured to do so.

A part of an exemplary NF profile of the UPF 175, which is related to IP address/prefix allocation, may be provided as follows:

| Attribute name | Data type | P | Cardinality | Description |
|---|---|---|---|---|
| dnn | Dnn | M | 1 | Supported DNN. The DNN shall contain the Network |
| | | | | Identifier and it may additionally contain an Operator |
| | | | | Identifier. If the Operator Identifier is not included, the |
| | | | | DNN is supported for all the PLMNs in the plmnList of |
| | | | | the NF Profile. |
| dnaiList | array(Dnai) | O | 1 . . . N | List of Data network access identifiers supported by |
| | | | | the UPF for this DNN. The absence of this attribute |
| | | | | indicates that the UPF can be selected for this DNN |
| | | | | for any DNAI. |
| pduSessionTypes | array(PduSessionType) | O | 1 . . . N | List of PDU session type(s) supported by the UPF for |
| | | | | a specific DNN. The absence of this attribute |
| | | | | indicates that the UPF can be selected for this DNN |
| | | | | for any PDU session type supported by the UPF (see |
| | | | | clause 6.1.6.2.13). |
| ipv4AddressRanges | array(Ipv4AddressRange) | O | 1 . . . N | List of ranges of IPv4 addresses handled by UPF. |
| | | | | (NOTE 1) |
| ipv6PrefixRanges | array(Ipv6PrefixRange) | O | 1 . . . N | List of ranges of IPv6 prefixes handled by the UPF. |
| | | | | (NOTE 1) |
| dnaiNwInstanceList | map(string) | O | 1 . . . N | Map of a network instance per DNAI for the DNN, |
| | | | | where the key of the map is the DNAI. |
| | | | | When present, the value of each entry of the map |
| | | | | shall contain a N6 network instance that is configured |
| | | | | for the DNAI indicated by the key. |
| | | | | (NOTE 2) |

(NOTE 1):
The list of ranges of IPv4/v6 address may be used by the SMF to select a UPF which supports a UE static IP address received in user subscription.
(NOTE 2):
This IE may be used by the SMF to determine the Network Instance associated to a given S-NSSAI, DNN and DNAI. If this IE is not present, the SMF needs to be configured with corresponding information.

Further, a part of exemplary subscription data that is related to IP address/prefix allocation and that can be provided by the UDM 160 may be provided as follows:

| Attribute name | Data type | P | Cardinality | Description |
|---|---|---|---|---|
| pduSessionTypes | PduSessionTypes | M | 1 | Default/Allowed session types |
| sscModes | SscModes | M | 1 | Default/Allowed SSC modes |
| iwkEpsInd | IwkEpsInd | O | 0 . . . 1 | Indicates whether interworking with EPS is |
| | | | | subscribed: |
| | | | | true: Subscribed; |
| | | | | false: Not subscribed; |
| | | | | If this attribute is absent it means not |
| | | | | subscribed. |
| 5gQosProfile | SubscribedDefaultQos | O | 0 . . . 1 | 5G QoS parameters associated to the session |
| | | | | for a data network |
| sessionAmbr | Ambr | O | 0 . . . 1 | The maximum aggregated uplink and downlink |
| | | | | bit rates to be shared across all Non-GBR QoS |
| | | | | Flows in each PDU Session |
| 3gppChargingCharac- | 3GppChargingCharac- | O | 0 . . . 1 | Subscribed charging characteristics data |
| teristics | teristics | | | associated to the session for a data network. |
| | | | | (NOTE 1) |
| staticIpAddress | array(IpAddress) | O | 1 . . . 2 | Subscribed static IP address(es) of the IPv4 |
| | | | | and/or IPv6 type |
| upSecurity | UpSecurity | O | 0 . . . 1 | When present, this IE shall indicate the security |
| | | | | policy for integrity protection and encryption for |
| | | | | the user plane. |
| ipv4Index | IpIndex | O | 0 . . . 1 | Indicates the “IP Index” (i.e. information that |
| | | | | identifies an address pool or an external |
| | | | | server) to be sent to the SMF for allocation of |
| | | | | an IPv4 address to the UE, for this DNN |
| | | | | configuration. |
| ipv6Index | IpIndex | O | 0 . . . 1 | Indicates the “IP Index” (i.e. information that |
| | | | | identifies an address pool or an external |
| | | | | server) to be sent to the SMF for allocation of |
| | | | | an IPv6 address to the UE, for this DNN |
| | | | | configuration. |
| ecsAddrConfigInfo | EcsAddrConfigInfo | O | 0 . . . 1 | ECS Address Configuration Information |
| | | | | Parameters. See 3GPP TS 23.502 [3] |

(NOTE 1):
When present, this attribute shall take precedence over the “3gppChargingCharacteristics” attribute in the SessionManagementSubscriptionData level.
NOTE 2:
These attributes shall be consistent with the information received on the 5GVnGroupData (see clause 6.5.6.2.7), in the Nudm_PP API. If both FQDN and IP addresses are provided, the IP addresses should be preferred to target the DN-AAA server.

Further, a part of an exemplary subscription data that is related to IP address/prefix allocation and that can be provided by the DN-AAA server 185 may be provided as follows:

| | Attribute | | | Presence |
|---|---|---|---|---|
| Attr # | Name | Description | Content | Requirement |
| 1 | User-Name | Username received in the Access-Request | String | Optional |
| | | message or a substitute username provided by the | | |
| | | AAA server. If the User-Name has been received in | | |
| | | the Access-Accept message, this user-name shall | | |
| | | be used in preference to the above | | |
| 100 | Framed- | Name of the IPv6 prefix pool for the specific APN | String | Optional |
| | IPv6-Pool | | | Note 2 |
| 88 | Framed- | Name of the IPv4 pool for the specific APN | String | Optional |
| | Pool | | | Note 2 |

NOTE 1:
The presence of this attribute is conditional upon this attribute being received in the Access-Accept message
NOTE 2:
IPv4 address and/or IPv6 prefix attributes shall be present. The IP protocol version for end-user and network may be different.

From above, according to the latest TS 29.510 (2022.3), “ipv4AddressRanges” and “ipv6PrefixRanges” are attributes of upfInfo\DnnUpfInfoItem, which are used for the SMF 125 selecting a UPF 175 which support UE static IP address.

| Attribute name | Data type | P | Cardinality | Description |
|---|---|---|---|---|
| ipv4AddressRanges | array(Ipv4AddressRange) | O | 1 . . . N | List of ranges of IPv4 addresses |
| | | | | handled by UPF. (NOTE 1) |
| ipv6PrefixRanges | array(Ipv6PrefixRange) | O | 1 . . . N | List of ranges of IPv6 prefixes |
| | | | | handled by the UPF. (NOTE 1) |

(NOTE 1):
The list of ranges of IPv4/v6 address may be used by the SMF to select a UPF which supports a UE static IP address received in user subscription.

Therefore, for a PDU session that UE 100 is allocated with a static IP address, when the SMF 125 performs NRF discovery to select the proper UPF 175, among the UPF list received from NRF 150, the SMF 125 will use ipv4AddressRanges/ipv6PrefixRanges of upfInfo to correctly select a UPF 175 that supports a UE static IP address that is received in user subscription from the UDM 160.

However, there are some cases that the SMF 125 cannot select a UPF 175 correctly.

In TS 29.503 as mentioned above, ipv4Index\ipv6Index attributes can be received in the SessionManagementSubscriptionData\DnnConfiguration data from the UDM 160 by UDM_SDM service during session establishment procedure. The ipv4Index/ipv6Index are the information that identifies an address pool or an external server) to be sent to the SMF 125 for allocation of an IPv4 address/IPv6 prefix to the UE 100 for this DNN.

| Attribute | | | | |
|---|---|---|---|---|
| name | Data type | P | Cardinality | Description |
| ipv4Index | IpIndex | O | 0 . . . 1 | Indicates the “IP Index” (i.e. information that identifies an address |
| | | | | pool or an external server) to be sent to the SMF for allocation of |
| | | | | an IPv4 address to the UE, for this DNN configuration. |
| ipv6Index | IpIndex | O | 0 . . . 1 | Indicates the “IP Index” (i.e. information that identifies an address |
| | | | | pool or an external server) to be sent to the SMF for allocation of |
| | | | | an IPv6 address to the UE, for this DNN configuration. |

Therefore, for a PDU session that the UE 100 is allocated with ipv4Index\ipv6Index from UDM user subscription, when the SMF 125 performs NRF discovery to select the proper UPF 175, among the UPF list received from NRF 150, if the UPF 175 cannot provide the supported IPv4/IPv6-prefix pool information (ipv4Index\ipv6Index), the SMF 125 cannot correctly select the UPF 175 for this PDU session.

In TS 29.561/TS 29.061 as mentioned above, Framed-Pool \ Framed-IPv6-Pool attributes can be received in the Access-Accept message from a RADIUS server (e.g., the DN-AAA server 185 or the NSS-AAA server 205) during session establishment procedure. The Framed-Pool \ Framed-IPv6-Pool attributes are the name of IPv4/IPv6 prefix pool for one DNN, and the SMF 125 may allocate UE IP address for one specific DNN from the Framed-Pool \ Framed-IPv6-Pool attribute received from the RADIUS Server.

| | Attribute | | | Presence |
|---|---|---|---|---|
| Attr # | Name | Description | Content | Requirement |
| 100 | Framed- | Name of the IPv6 prefix | String | Optional |
| | IPv6-Pool | pool for the specific APN | | Note 2 |
| 88 | Framed- | Name of the IPv4 pool for | String | Optional |
| | Pool | the specific APN | | Note 2 |

Therefore, for a PDU session that UE 100 is allocated with Framed-Pool\Framed-IPv6-Pool attribute from the RADIUS Server, when the SMF 125 performs NRF discovery to select the proper UPF 175, among the UPF list received from NRF 150, if the UPF 175 cannot provide the supported IPv4/IPv6-prefix pool information (Framed-Pool\Framed-IPv6-Pool), the SMF 125 cannot correctly select the UPF 175 for this PDU session.

In some embodiments of the present disclosure, when a UPF 175 registers to the NRF 150, the UPF 175 may include at least one of the following attributes in upfInfo that is transmitted to the NRF 150:
ipv4Index; and
ipv6Index.

However, the present disclosure is not limited thereto. In some other embodiments, one or more attributes with different names may be used.

In some embodiments of the present disclosure, when the SMF 125 receives ipv4Index and/or ipv6Index from the UDM 160 or RADIUS Server, the SMF 125 may send NRF Discovery Request with at least one of new Query parameters (ipv4Index, ipv6Index) to find the proper UPFs 175, and the NRF 150 may send the UPFs 175 which meet the new Query parameter (ipv4Index, ipv6Index). In this way, the SMF 125 can correctly select the UPF 175 which supports this ipv4Index\ ipv6Index for the UE PDU session.

In some embodiments of the present disclosure, when the SMF 125 receives ipv4Index and or ipv6Index from the UDM 160 or RADIUS Server, the SMF 125 may send NRF Discovery Request, and NRF 150 may send back the UPFs 175. In this case, the SMF 125 can correctly select, from the discovered UPFs 175, the UPF 175 which supports the ipv4Index\ ipv6Index for the UE PDU session.

In some embodiments, the ipv4Index and ipv6Index can be present together or present individually, which depends on the allocated UE IP address type: IPv4, IPv6, IPv4IPv6.

With these two attributes in upfInfo and Query Parameter of NRF discovery Request, if an SMF receives ipv4Index\ipv6Index from a UDM or RADIUS Server, the SMF can correctly select a UPF which supports this ipv4Index\ ipv6Index for a UE PDU session.

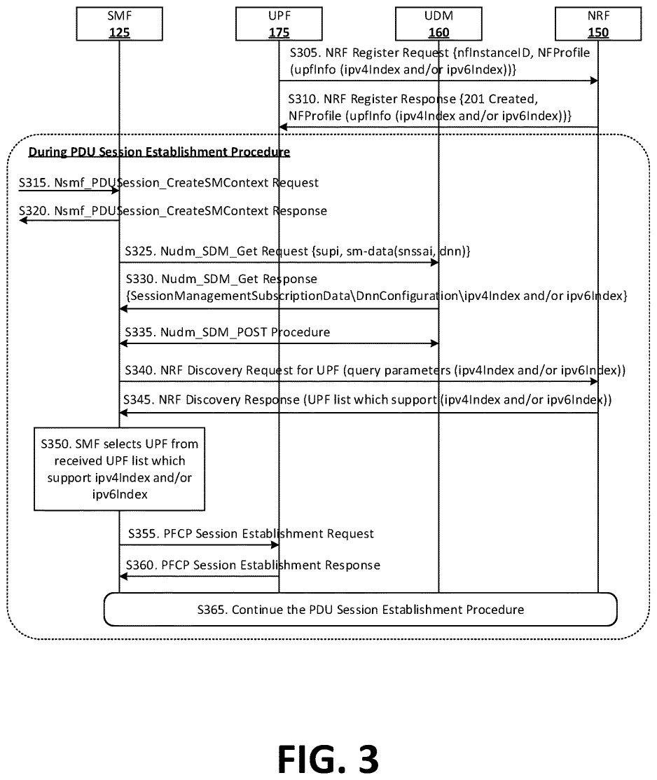

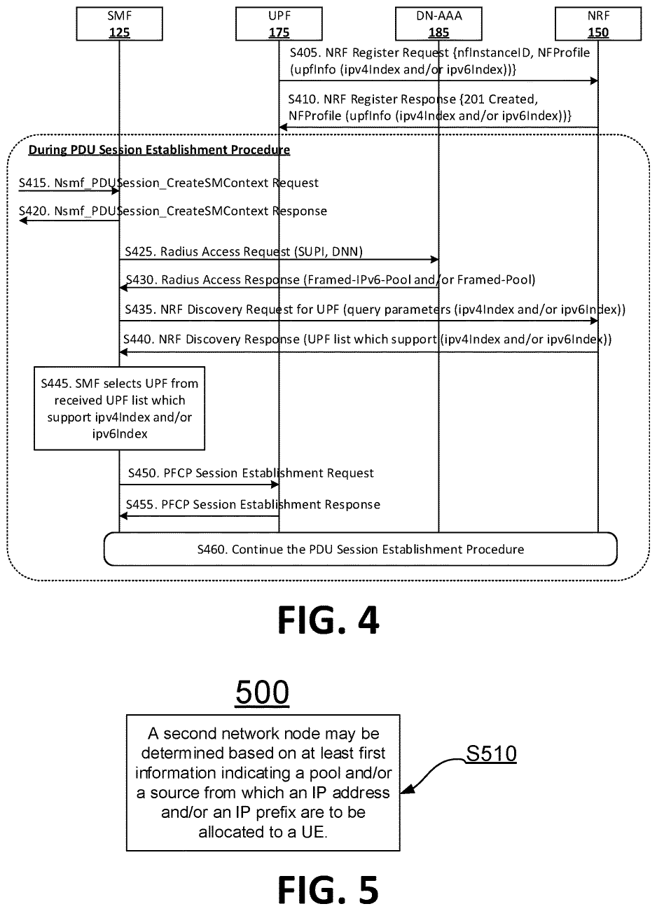

Next, some embodiments will be described in details with reference to FIG. 3 and FIG. 4.

FIG. 3 is a diagram illustrating an exemplary procedure for enhanced NF registration and discovery according to an embodiment of the present disclosure. As shown in FIG. 3, the procedure may begin at step S305 where the UPF 175 may register itself with the NRF 150 for NF discovery, for example, by transmitting an NRF Register Request with attributes in upfInfo: Ipv4Index and/or ipv6Index, as will be described below in detail. In some embodiments, the NRF Register Request message may be an Nnrf_NFManagement_NFRegister request message.

At step S310, the NRF 150 may transmit to the UPF 175 an NRF Register Response with success when the registration is successful. In some embodiments, the NRF Register Response message may be an Nnrf_NFManagement_NFRegister response message.

After that, a PDU Session Establishment procedure may be initiated for the UE 100, and during this procedure, the SMF 125 may receive an Nsmf_PDUSession_CreateSMContext Request from the AMF 120 at step S315, and the SMF 125 may transmit an Nsmf_PDUSession_CreateSMContext Response to the AMF 120 at step S320 in response to the request. However, the present disclosure is not limited thereto. In some other embodiments, the SMF 125 may be triggered by another event (e.g., another message, a timer, or other trigger) to discover a UPF 175 or another NF that supports the ipv4Index and/or ipv6Index.

At step S325, the SMF 125 may transmit an Nudm_SDM_GET Request (supi, sm-data (snssai, dnn)) to the UDM 160, for example, to retrieve subscription data for the UE 100.

At step S330, the UDM 160 may transmit an Nudm_SDM_GET Response with SessionManagementSubscriptionData\DnnConfiguration\ipv4Index and/or ipv6Index to the SMF 125.

At step S335, the SMF 125 may perform an Nudm_SDM_POST procedure to the UDM 160, for example, to subscribe to notifications of data change of the subscription data.

At step S340, the SMF 125 may transmit an NRF Discovery Request for UPF (query parameters ipv4Index and/or ipv6Index) to the NRF 150. In some embodiments, the NRF Discovery Request message may be an Nnrf_NFDiscovery_Request request message. However, the present disclosure is not limited thereto. In some other embodiments, the SMF 125 may transmit the NRF Discovery Request without any of the query parameters, such that the NRF 150 may return, for example, all NFs that have the requested NF type/NF service type it finds.

At step S345, the NRF 150 may transmit an NRF Discovery Response (UPF list which supports ipv4Index and/or ipv6Index) to the SMF 125. In some embodiments, the NRF Discovery Response message may be an Nnrf_NFDiscovery_Request response message. For example, the NRF 150 may include the UPFs 175 with registered and matched attributes, “ipv4Index” and/or “ipv6Index” in the UPF list.

At step S350, the SMF 125 may select the UPF 175 from the received UPF list which supports ipv4Index and/or ipv6Index.

At step S355, the SMF 125 may transmit a PFCP Session Establishment Request to the selected UPF 175 for establishing a PFCP session for the PDU session that is being established.

At step S360, the UPF 175 may transmit a PFCP Session Establishment Response to the SMF 125 upon the PFCP session is successfully established.

At step S365, the SMF 125 may continue the PDU Session Establishment Procedure.

With the embodiment shown in FIG. 3, the SMF 125 can correctly select the UPF 175 which supports the indicated ipv4Index\ ipv6Index for the PDU session. However, the present disclosure is not limited thereto, and this mechanism can also be applicable in other NF registration and/or NF discovery based on the IP index.

FIG. 4 is a diagram illustrating another exemplary procedure for enhanced NF registration and discovery according to another embodiment of the present disclosure. Unlike the embodiment shown in FIG. 3, the DN-AAA server 185 is present and provides information related to IP address/prefix allocation.

As shown in FIG. 4, the procedure may begin at step S405 where the UPF 175 may register itself with the NRF 150 for NF discovery, for example, by transmitting an NRF Register Request with new attributes in upfInfo: Ipv4Index and/or ipv6Index. In some embodiments, the NRF Register Request message may be an Nnrf_NFManagement_NFRegister request message.

At step S410, the NRF 150 may transmit to the UPF 175 an NRF Register Response with success when the registration is successful. In some embodiments, the NRF Register Response message may be an Nnrf_NFManagement_NFRegister response message.

After that, a PDU Session Establishment procedure may be initiated for the UE 100, and during this procedure, the SMF 125 may receive an Nsmf_PDUSession_CreateSMContext Request from the AMF 120 at step S415, and the SMF 125 may transmit an Nsmf_PDUSession_CreateSMContext Response to the AMF 120 at step S420 in response to the request. However, the present disclosure is not limited thereto. In some other embodiments, the SMF 125 may be triggered by another event (e.g., another message, a timer, or other trigger) to discover a UPF 175 or another NF that supports the ipv4Index and/or ipv6Index.

At step S425, the SMF 125 may transmit a RADIUS Access Request (SUPI, DNN) to a RADIUS server (e.g., the DN-AAA server 185), for example, for authentication and/or authorization of the UE 100 and/or the PDU session.

At step S430, the DN-AAA server 185 may transmit a RADIUS Access Response (Framed-Pool and/or Framed-IPv6-Pool) to the SMF 125. In some embodiments, the RADIUS Access Response message may be an Access Accept message.

At step S435, the SMF 125 may transmit an NRF Discovery Request for UPF (query parameters ipv4Index and/or ipv6Index) to the NRF 150. In some embodiments, the NRF Discovery Request message may be an Nnrf_NFDiscovery_Request request message. In some embodiments, the parameters (Framed-Pool and/or Framed-IPv6-Pool) received from the DN-AAA server 185 at step S430 may be used as the query parameters (ipv4Index and/or ipv6Index), respectively. However, the present disclosure is not limited thereto. In some other embodiments, the SMF 125 may transmit the NRF Discovery Request without any of the query parameters, such that the NRF 150 may return, for example, all NFs that have the requested NF type/NF service type it finds.

At step S440, the NRF 150 may transmit an NRF Discovery Response (UPF list which supports ipv4Index and/or ipv6Index) to the SMF 125. In some embodiments, the NRF Discovery Response message may be an Nnrf_NFDiscovery_Request response message. For example, the NRF 150 may include the UPFs 175 with registered and matched attributes, “ipv4Index” and/or “ipv6Index” in the UPF list.

At step S445, the SMF 125 may select the UPF 175 from the received UPF list which supports ipv4Index and/or ipv6Index.

At step S450, the SMF 125 may transmit a PFCP Session Establishment Request to the selected UPF 175 for establishing a PFCP session for the PDU session that is being established.

At step S455, the UPF 175 may transmit a PFCP Session Establishment Response to the SMF 125 upon the PFCP session is successfully established.

At step S460, the SMF 125 may continue the PDU Session Establishment Procedure.

With the embodiment shown in FIG. 4, the SMF 125 can also correctly select the UPF 175 which supports the indicated Framed-Pool and/or Framed-IPv6-Pool (corresponding to ipv4Index and/or ipv6Index) for the PDU session. However, the present disclosure is not limited thereto, and this mechanism can also be applicable in other NF registration and/or NF discovery based on the IP index.

Below please find some exemplary parameters/attributes that can be provided in the 3GPP Technical Specifications, e.g. in the context of the aforementioned 3GPP TS 29.510, and can be used in the procedures above.

A part of an exemplary NF profile of the UPF 175, which is related to IP address/prefix allocation, may be provided as follows:

TABLE 6.1.6.2.15-1
Definition of type DnnUpfInfoltem

| Attribute name | Data type | P | Cardinality | Description |
|---|---|---|---|---|
| dnn | Dnn | M | 1 | Supported DNN. The DNN shall contain the Network |
| | | | | Identifier and it may additionally contain an Operator |
| | | | | Identifier. If the Operator Identifier is not included, the |
| | | | | DNN is supported for all the PLMNs in the plmnList of the |
| | | | | NF Profile. |
| dnaiList | array(Dnai) | O | 1 . . . N | List of Data network access identifiers supported by the |
| | | | | UPF for this DNN. The absence of this attribute indicates |
| | | | | that the UPF can be selected for this DNN for any DNAI. |
| pduSessionTypes | array(PduSessionType) | O | 1 . . . N | List of PDU session type(s) supported by the UPF for a |
| | | | | specific DNN. The absence of this attribute indicates that |
| | | | | the UPF can be selected for this DNN for any PDU |
| | | | | session type supported by the UPF (see clause |
| | | | | 6.1.6.2.13). |
| ipv4AddressRanges | array(Ipv4AddressRange) | O | 1 . . . N | List of ranges of IPv4 addresses handled by UPF. |
| | | | | (NOTE 1) |
| ipv6PrefixRanges | array(Ipv6PrefixRange) | O | 1 . . . N | List of ranges of IPv6 prefixes handled by the UPF. |
| | | | | (NOTE 1) |
| ipv4Index | array (ipIndex) | O | 0 . . . N | List of ipv4Index handled by UPF. (NOTE 3) |
| ipv6Index | array (ipIndex) | O | 0 . . . N | List of ipv6Index handled by UPF. (NOTE 3) |
| dnaiNwInstanceList | map(string) | O | 1 . . . N | Map of a network instance per DNAI for the DNN, where |
| | | | | the key of the map is the DNAI. |
| | | | | When present, the value of each entry of the map shall |
| | | | | contain a N6 network instance that is configured for the |
| | | | | DNAI indicated by the key. |
| | | | | (NOTE 2) |

(NOTE 1):
The list of ranges of IPv4/v6 address may be used by the SMF to select a UPF which supports a UE static IP address received in user subscription.
(NOTE 2):
This IE may be used by the SMF to determine the Network Instance associated to a given S-NSSAI, DNN and DNAI. If this IE is not present, the SMF needs to be configured with corresponding information.
(NOTE 3):
The list of ipv4Index/ipv6Index may be used by the SMF to select a UPF which supports a UE with ipv4Index/ipv6Index received from the external server (e.g, UDM, Radius)

For retrieving a list of NF instances and their offered services that satisfy certain conditions, the following parameters may be used in an according request, e.g. a GET request:

TABLE 6.2.3.2.3.1-1
URI query parameters supported by the GET method on this resource

| Name | Data type | P | Cardinality | Description | Applicability |
|---|---|---|---|---|---|
| target-nf- | NFType | M | 1 | This IE shall contain the NF type of the target NF being | |
| type | | | | discovered. | |
| ue-ipv4- | Ipv4Addr | O | 0 . . . 1 | The IPv4 address of the UE for which a BSF or P-CSCF | |
| address | | | | needs to be discovered. | |
| ip-domain | string | O | 0 . . . 1 | The IPv4 address domain of the UE for which a BSF needs | |
| | | | | to be discovered. | |
| ue-ipv6- | Ipv6Prefix | O | 0 . . . 1 | The IPv6 prefix of the UE for which a BSF or P-CSCF needs | |
| prefix | | | | to be discovered. | |
| ipv4Index | array (ipIndex) | O | 0 . . . N | List of ipv4Index handled by UPF. (NOTE X) | ipv4Index |
| ipv6Index | array (ipIndex) | O | 0 . . . N | List of ipv6Index handled by UPF. (NOTE X) | ipv6Index |

(NOTE X):
The list of ipv4Index/ipv6Index may be used by the SMF to select a UPF which supports a UE with ipv4Index/ipv6Index received from the external server (e.g, UDM, Radius)

Therefore, with these two attributes in upfInfo and Query Parameter of NRF discovery Request, if the SMF receives ipv4Index\ ipv6Index from the UDM or RADIUS Server, the SMF can correctly select the UPF which supports this ipv4Index\ ipv6Index for the UE PDU session.

FIG. 5 is a flow chart of an exemplary method 500 at a first network node for selecting a second network node to serve a UE. The method 500 may be performed by an SMF (e.g., the SMF 125). The method 500 may comprise a step S510. However, the present disclosure is not limited thereto. In some other embodiments, the method 500 may comprise more steps, different steps, or any combination thereof. Further the steps of the method 500 may be performed in a different order than that described herein. Further, in some embodiments, a step in the method 500 may be split into multiple sub-steps and performed by different entities, and/or multiple steps in the method 500 may be combined into a single step.

The method 500 may begin at step S510 where the second network node may be determined based on at least first information indicating a pool and/or a source from which an IP address and/or an IP prefix are to be allocated to the UE.

In some embodiments, the step of determining the second network node may comprise: transmitting, to a third network node, a first message for discovering one or more second network nodes, the first message further comprising the first information; receiving, from the third network node, a second message indicating at least one second network node that is able to handle the pool and/or the source indicated by the information; and selecting one of the at least one second network node as the second network node that is to serve the UE. In some embodiments, the step of determining the second network node may comprise: transmitting, to a third network node, a first message for discovering one or more second network nodes; receiving, from the third network node, a second message indicating at least one second network node; and selecting one of the at least one second network node that is able to handle the pool and/or the source indicated by the first information, as the second network node that is to serve the UE.

In some embodiments, the first information may indicate at least one of: an IPv4 address pool used to allocate the IP address; an IPv6 prefix pool used to allocate the IP address and/or the IP prefix; and an external server used to allocate the IP address and/or the IP prefix. In some embodiments, before the step of determining the second network node, the method 500 may further comprise at least one of: transmitting, to a fourth network node, a third message for requesting session management subscriber data associated with the UE; and receiving, from the fourth network node, a fourth message indicating the first information. In some embodiments, the third message may further indicate at least one of S-NSSAI and/or a DNN subscribed by the UE. In some embodiments, the first information may be comprised in a DNN configuration associated with the S-NSSAI and/or the DNN.

In some embodiments, before the step of determining the second network node, the method 500 may further comprise at least one of: transmitting, to a fifth network node, a fifth message for authenticating and/or authorizing the UE with the fifth network node; and receiving, from the fifth network node, a sixth message indicating the first information. In some embodiments, the fifth message may further indicate a DNN subscribed by the UE. In some embodiments, the method 500 may further comprise: communicating with the determined second network node to establish a session for the UE. In some embodiments, at least one of following may be true: the first network node may be an SMF or a PGW-C; the second network node may be a UPF or a PGW-U; the third network node may be a NRF; the fourth network node may be a UDM; the fifth network node may be a DN-AAA server; the first message may be an Nnrf_NFDiscovery_Request request message; the second message may be an Nnrf_NFDiscovery_Request response message; the third message may be an Nudm_SDM_Get request message; the fourth message may be an Nudm_SDM_Get response message; the fifth message may be an Access Request message; and the sixth message may be an Access Accept message.

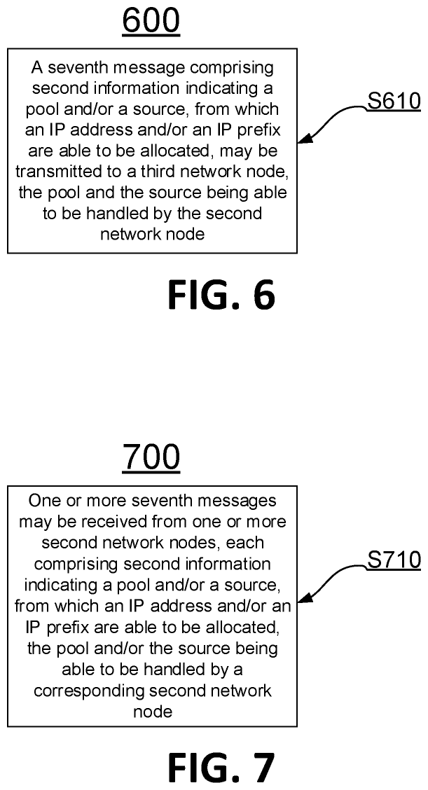

FIG. 6 is a flow chart of an exemplary method 600 at a second network node for facilitating a first network node in selecting the second network node to serve a UE. The method 600 may be performed by a UPF (e.g., the UPF 175). The method 600 may comprise a step S610. However, the present disclosure is not limited thereto. In some other embodiments, the method 600 may comprise more steps, different steps, or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610 where a seventh message comprising second information indicating a pool and/or a source, from which an IP address and/or an IP prefix are able to be allocated may be transmitted to a third network node. In some embodiments, the pool and/or the source are able to be handled by the second network node.

In some embodiments, the second information may indicate at least one of: an IPv4 address pool used to allocate the IP address; an IPv6 prefix pool used to allocate the IP address and/or the IP prefix; and an external server used to allocate the IP address and/or the IP prefix. In some embodiments, the method 600 may further comprise: communicating with the first network node to establish a session for the UE. In some embodiments, the seventh message may be a message for registering an NF profile for the second network node at the third network node. In some embodiments, the method 600 may further comprise: receiving, from the third network node, an eighth message indicating whether the registration is successful or not. In some embodiments, at least one of following may be true: the first network node may be an SMF or a PGW-C; the second network node may be a UPF or a PGW-U; the third network node may be an NRF; the seventh message may be an Nnrf_NFManagement_NFRegister request message; and the eighth message may be an Nnrf_NFManagement_NFRegister response message.

FIG. 7 is a flow chart of an exemplary method 700 at a third network node for enabling a second network node to be discoverable. The method 700 may be performed by an NRF (e.g., the NRF 150). The method 700 may comprise a step S710. However, the present disclosure is not limited thereto. In some other embodiments, the method 700 may comprise more steps, different steps, or any combination thereof. Further the steps of the method 700 may be performed in a different order than that described herein. Further, in some embodiments, a step in the method 700 may be split into multiple sub-steps and performed by different entities, and/or multiple steps in the method 700 may be combined into a single step.

The method 700 may begin at step S710 where one or more seventh messages may be received from one or more second network nodes, each comprising second information indicating a pool and/or a source, from which an IP address and/or an IP prefix are able to be allocated, the pool and/or the source being able to be handled by a corresponding second network node.

In some embodiments, each of the one or more seventh messages may be a message for registering an NF profile for a corresponding second network node at the third network node. In some embodiments, the method 700 may further comprise: transmitting, to at least one of the one or more second network nodes, an eighth message indicating whether the corresponding registration is successful or not. In some embodiments, the method 700 may further comprise: receiving, from a first network node, a first message for discovering one or more second network nodes, the first message further comprising first information indicating a pool and/or a source from which an IP address and/or an IP prefix are to be allocated to a UE; determining at least one second network node in response to determining that the second information corresponding to the at least one second network node matches with the first information; transmitting, to the first network node, a second message indicating the determined at least one second network node.

In some embodiments, the method 700 may further comprise: receiving, from a first network node, a first message for discovering one or more second network nodes without the first information indicated; transmitting, to the first network node, a second message indicating at least one second network node registered at the third network node. In some embodiments, at least one of the first information and the second information may indicate at least one of: an IPv4 address pool used to allocate the IP address; an IPv6 prefix pool used to allocate the IP address and/or the IP prefix; and an external server used to allocate the IP address and/or the IP prefix.

In some embodiments, at least one of following may be true: the first network node may be an SMF or a PGW-C; the second network node may be a UPF or a PGW-U; the third network node may be an NRF; the first message may be an Nnrf_NFDiscovery_Request request message; the second message may be an Nnrf_NFDiscovery_Request response message; the seventh message may be an Nnrf_NFManagement_NFRegister request message; and the eighth message may be an Nnrf_NFManagement_NFRegister response message.

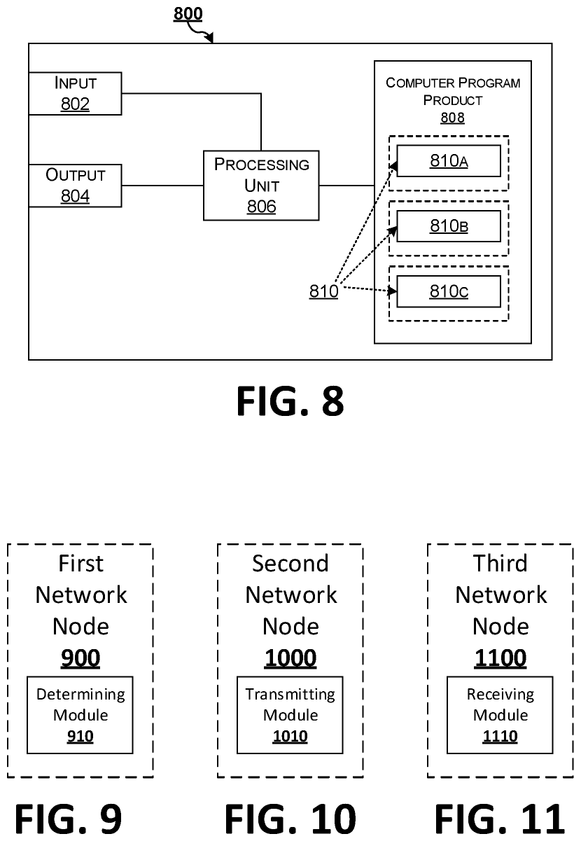

FIG. 8 schematically shows an embodiment of an arrangement which may be used in one or more network nodes (e.g., SMF, UPF, and/or NRF) according to an embodiment of the present disclosure. Comprised in the arrangement 800 are a processing unit 806, e.g., with a Digital Signal Processor (DSP) or a Central Processing Unit (CPU). The processing unit 806 may be a single unit or a plurality of units to perform different actions of procedures described herein. The arrangement 800 may also comprise an input unit 802 for receiving signals from other entities, and an output unit 804 for providing signal(s) to other entities. The input unit 802 and the output unit 804 may be arranged as an integrated entity or as separate entities.

Furthermore, the arrangement 800 may comprise at least one computer program product 808 in the form of a non-volatile or volatile memory, e.g., an Electrically Erasable Programmable Read-Only Memory (EEPROM), a flash memory and/or a hard drive. The computer program product 808 comprises a computer program 810, which comprises code/computer readable instructions, which when executed by the processing unit 806 in the arrangement 800 causes the arrangement 800 and/or the network node(s) in which it is comprised to perform the actions, e.g., of the procedure described earlier in conjunction with FIG. 3 through FIG. 7 or any other variant.

The computer program 810 may be configured as a computer program code structured in a computer program module 810A. Hence, in an exemplifying embodiment when the arrangement 800 is used in a first network node for selecting a second network node to serve a UE, the code in the computer program of the arrangement 800 includes: a module 810A configured to determine the second network node based on at least first information indicating a pool and/or a source from which an IP address and/or an IP prefix are to be allocated to the UE. In some embodiments, the first network node may comprise one or more further modules configured to configured to perform one or more steps of any of the methods described with reference to FIG. 5.

Additionally or alternatively, the computer program 810 may be configured as a computer program code structured in a computer program module 810B. Hence, in an exemplifying embodiment when the arrangement 800 is used in a second network node for facilitating a first network node in selecting the second network node to serve a UE, the code in the computer program of the arrangement 800 includes: a module 810B configured to transmit, to a third network node, a seventh message comprising second information indicating a pool and/or a source, from which an IP address and/or an IP prefix are able to be allocated, the pool and/or the source being able to be handled by the second network node. In some embodiments, the second network node may comprise one or more further modules configured to configured to perform one or more steps of any of the methods described with reference to FIG. 6.

Additionally or alternatively, the computer program 810 may be configured as a computer program code structured in a computer program module 810C. Hence, in an exemplifying embodiment when the arrangement 800 is used in a third network node for enabling a second network node to be discoverable, the code in the computer program of the arrangement 800 includes: a module 810C configured to receive, from one or more second network nodes, one or more seventh messages, each comprising second information indicating a pool and/or a source, from which an IP address and/or an IP prefix are able to be allocated, the pool and/or the source being able to be handled by a corresponding second network node. In some embodiments, the third network node may comprise one or more further modules configured to perform one or more steps of any of the methods described with reference to FIG. 7.

The computer program modules could essentially perform the actions of the flow illustrated in FIG. 3 through FIG. 7, to emulate the network node(s). In other words, when the different computer program modules are executed in the processing unit 806, they may correspond to different modules in the network node(s).

Although the code means in the embodiments disclosed above in conjunction with FIG. 8 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network node(s).

Correspondingly to the method 500 as described above, an exemplary first network node for selecting a second network node to serve a UE is provided. FIG. 9 is a block diagram of a first network node 900 according to an embodiment of the present disclosure. The first network node 900 may be, e.g., the SMF 125 in some embodiments.

The first network node 900 may be configured to perform the method 500 as described above in connection with FIG. 5. As shown in FIG. 9, the first network node 900 may comprise a determining module 910 configured to determine the second network node based on at least first information indicating a pool and/or a source from which an IP address and/or an IP prefix are to be allocated to the UE.

The above module 910 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the first network node 900 may comprise one or more further modules, each of which may perform any of the steps of the method 500 described with reference to FIG. 5.

Correspondingly to the method 600 as described above, an exemplary second network node for facilitating a first network node in selecting the second network node to serve a UE is provided. FIG. 10 is a block diagram of a second network node 1000 according to an embodiment of the present disclosure. The second network node 1000 may be, e.g., the UPF 175 in some embodiments.

The second network node 1000 may be configured to perform the method 600 as described above in connection with FIG. 6. As shown in FIG. 10, the second network node 1000 may comprise a transmitting module 1010 configured to transmit, to a third network node, a seventh message comprising second information indicating a pool and/or a source, from which an IP address and/or an IP prefix are able to be allocated, the pool and/or the source being able to be handled by the second network node.

The above module 1010 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 6. Further, the second network node 1000 may comprise one or more further modules, each of which may perform any of the steps of the method 600 described with reference to FIG. 6.

Correspondingly to the method 700 as described above, an exemplary third network node for enabling a second network node to be discoverable is provided. FIG. 11 is a block diagram of a third network node 1100 according to an embodiment of the present disclosure. The third network node 1100 may be, e.g., the NRF 150 in some embodiments.

The third network node 1100 may be configured to perform the method 700 as described above in connection with FIG. 7. As shown in FIG. 11, the third network node 1100 may comprise a receiving module 1110 configured to receive, from one or more second network nodes, one or more seventh messages, each comprising second information indicating a pool and/or a source, from which an IP address and/or an IP prefix are able to be allocated, the pool and/or the source being able to be handled by a corresponding second network node.

The above module 1110 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 7. Further, the third network node 1100 may comprise one or more further modules, each of which may perform any of the steps of the method 700 described with reference to FIG. 7.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1. A method, performed by a first network node, for selecting a second network node to serve a User Equipment, the method comprising:
determining the second network node based on at least first information indicating one or both of a pool and a source from which one or both of an Internet Protocol, address and an IP prefix are to be allocated to the UE.

2. The method of claim 1, wherein determining the second network node comprises:
transmitting, to a third network node, a first message for discovering one or more second network nodes, the first message further comprising the first information;
receiving, from the third network node, a second message indicating at least one second network node that is able to handle the one or both of the pool and the source indicated by the first information; and
selecting one of the at least one second network node as the second network node that is to serve the UE.

3. The method of claim 1, wherein determining the second network node comprises:
transmitting, to a third network node, a first message for discovering one or more second network nodes;
receiving, from the third network node, a second message indicating at least one second network node; and
selecting one of the at least one second network node that is able to handle the one or both of the pool and the source indicated by the first information, as the second network node that is to serve the UE.

4. The method of claim 1, wherein the first information indicates at least one of:
an IP Version 4 address pool used to allocate the IP address;
an IP Version 6 prefix pool used to allocate the one or both of the IP address and the IP prefix; and
an external server used to allocate the one or both of the IP address and the IP prefix.

5. The method of claim 1, wherein before determining the second network node, the method further comprises at least one of:
transmitting, to a fourth network node, a third message for requesting session management subscriber data associated with the UE; and
receiving, from the fourth network node, a fourth message indicating the first information.

6. The method of claim 5, wherein the third message further indicates one or both of Single Network Slice Selection Assistance Information (S-NSSAI) and a Data Network Name (DNN) subscribed by the UE, wherein the first information is comprised in a DNN configuration associated with the one or both of the S-NSSAI and the DNN.

7. The method of claim 1, wherein before determining the second network node, the method further comprises at least one of:
transmitting, to a fifth network node, a fifth message for one or both authenticating and authorizing the UE with the fifth network node; and
receiving, from the fifth network node, a sixth message indicating the first information.

8. The method of claim 7, wherein the fifth message further indicates a DNN subscribed by the UE.

9. The method of claim 1, further comprising:
communicating with the determined second network node to establish a session for the UE.

10. The method of claim 1, wherein at least one of following is true:
the first network node is a Session Management Function (SMF) or a Packet Data Network (PDN) Gateway-Control plane function (PGW-C);
the second network node is a User Plane Function (UPF) or a PGW-User plane function (PGW-U);
the third network node is a Network Repository Function (NRF);
the fourth network node is a Unified Data Management (UDM);
the fifth network node is a Data Network-Authentication, Authorization, and Accounting (DN-AAA) server;
the first message is an Nnrf_NFDiscovery_Request request message;
the second message is an Nnrf_NFDiscovery_Request response message;
the third message is an Nudm_SDM_Get request message;
the fourth message is an Nudm_SDM_Get response message;
the fifth message is an Access Request message; and
the sixth message is an Access Accept message.

11. (canceled)

12. A first network node, comprising:
a processor;
a memory storing instructions which, when executed by the processor, cause the processor to select a second network node to serve a User Equipment (UE) by configuring the processor to:
determine the second network node based on at least first information indicating one or both of a pool and a source from which one or both of an Internet Protocol (IP) address and an IP prefix are to be allocated to the UE.

13.-19. (canceled)

20. A method performed by a third network node for enabling a second network node to be discoverable by a first network node, the method comprising:
receiving, from one or more second network nodes, one or more seventh messages, each comprising second information indicating one or both of a pool and a source, from which one or both of an IP address and an IP prefix are able to be allocated, the one or both of the pool and the source being able to be handled by a corresponding second network node;
receiving, from the first network node, a first message for discovering one or more second network nodes, the first message further comprising first information indicating one or both of a pool and a source from which one or both of an IP address and an IP prefix are to be allocated to a UE;
determining at least one second network node in response to determining that the second information corresponding to the at least one second network node matches with the first information;
transmitting, to the first network node, a second message indicating the determined at least one second network node; and
thereby enabling the first network node to select a second network node from the determined at least one second network node for serving a UE.

21. The method of claim 20, wherein each of the one or more seventh messages is a message for registering an NF profile for a corresponding second network node at the third network node; and
wherein the method further comprises:
transmitting, to at least one of the one or more second network nodes, an eighth message indicating whether the corresponding registration is successful or not.

22. (canceled)

23. The method of claim 20, further comprising:
receiving, from a first network node, a first message for discovering one or more second network nodes without the first information indicated;
transmitting, to the first network node, a second message indicating at least one second network node registered at the third network node.

24. The method of claim 20, wherein at least one of the first information and the second information indicates at least one of:
an IPv4 address pool used to allocate the IP address;
an IPv6 prefix pool used to allocate one or both of the IP address and the IP prefix; and
an external server used to allocate one or both of the IP address and the IP prefix.

25. The method of claim 20, wherein at least one of following is true:
the first network node is an SMF or a PGW-C;
the second network node is a UPF or a PGW-U;
the third network node is an NRF;
the first message is an Nnrf_NFDiscovery_Request request message;
the second message is an Nnrf_NFDiscovery_Request response message;
the seventh message is an Nnrf_NFManagement_NFRegister request message; and
the eighth message is an Nnrf_NFManagement_NFRegister response message.

26. (canceled)

27. A third network node, comprising:
a processor;
a memory storing instructions which, when executed by the processor, cause the processor to enable a second network node to be discoverable by a first network node by configuring the processor to:
receive, from one or more second network nodes, one or more seventh messages, each comprising second information indicating one or both of a pool and a source, from which one or both of an IP address and an IP prefix are able to be allocated, the one or both of the pool and the source being able to be handled by a corresponding second network node;
receive, from the first network node, a first message for discovering one or more second network nodes, the first message further comprising first information indicating one or both of a pool and a source from which one or both of an IP address and an IP prefix are to be allocated to a UE;
determine at least one second network node in response to determining that the second information corresponding to the at least one second network node matches with the first information;
transmit, to the first network node, a second message indicating the determined at least one second network node; and
thereby enable the first network node to select a second network node from the determined at least one second network node for serving a UE.

28.-30. (canceled)

31. The first network node of claim 12, wherein the processor determines the second network node by being configured to:
transmit, to a third network node, a first message for discovering one or more second network nodes, the first message further comprising the first information;
receive, from the third network node, a second message indicating at least one second network node that is able to handle the one or both of the pool and the source indicated by the first information; and
select one of the at least one second network node as the second network node that is to serve the UE.

32. The first network node of claim 12, wherein the processor determines the second network node by being configured to:
transmit, to a third network node, a first message for discovering one or more second network nodes;
receive, from the third network node, a second message indicating at least one second network node; and
select one of the at least one second network node that is able to handle the one or both of the pool and the source indicated by the first information, as the second network node that is to serve the UE.
